(19) United States
(12) Patent Application Publication
(10) Pub. No.: US 2026/0141210 A1
(43) Pub. Date: May 21, 2026

(54) PROCESSOR-IMPLEMENTED METHODS AND SYSTEMS FOR MODEL OPTIMIZATION

(71) Applicant: Salesforce, Inc., San Francisco, CA (US)

(72) Inventors: Chi Wang, Bellevue, WA (US); Jianxiang Chang, Mountain View, CA (US); Peiheng Hu, San Francisco, CA (US); Seetharaman Gudetee, San Francisco, CA (US); Sandeep Bansal, San Ramon, CA (US); Bhavesh Doshi, Bellevue, WA (US)

(73) Assignee: Salesforce, Inc., San Francisco, CA (US)

(21) Appl. No.: 18/951,238

(22) Filed: Nov. 18, 2024

(51) Int. Cl. G06N 3/04

(52) U.S. Cl. CPC G06N 3/04

(57) ABSTRACT

Processor-implemented methods and systems are disclosed for optimizing pre-existing large language models for model inference. Different types of optimization techniques are provided to an offline optimization program. Within a generic model framework, different combinations of large language model serving configurations are generated. An automated online program optimizes the pre-existing large language models using large language model optimization configurations.

### TECHNICAL FIELD

Embodiments of the subject matter described herein relate generally to processor-implemented methods and systems for large language model optimization and more particularly to embodiments of the subject matter related to systems and methods for processor-implemented methods and systems for automating large language model optimization.

### BACKGROUND

Data scientists and machine learning engineers have to manually try out various combinations of deployment host types, inference engine/framework, quantization, and many other techniques before a new large language model (LLM) is put into production for inferencing. Further, they must manually run comparison performance benchmark tests to balance out the accuracy of inferencing done by the LLMs with the performance and cost of doing inferencing. Once they obtain a preferable combination, then this new model is deployed in production. Additionally, as new model optimization techniques are invented, the possible combinations to test increase exponentially. This is a very resource heavy workload and also can take a long time, sometimes in the order of 2-3 weeks per model.

### BRIEF DESCRIPTION OF THE DRAWINGS

The present disclosure will hereinafter be described in conjunction with the following drawing figures, wherein like numerals denote like elements, and wherein:

FIG. 1 is a block diagram representation of a system for optimizing large language models (LLMs) in accordance with at least one embodiment;

FIG. 2 is a block diagram representation of a system involving an offline automated model optimization flow in accordance with at least one embodiment;

FIG. 3 is a block diagram representation of a system involving an offline automated model optimization flow where new optimization techniques are to be added in accordance with at least one embodiment;

FIG. 4 is a block diagram representation of a system involving an offline automated model optimization flow interacting with an online optimization flow in accordance with at least one embodiment;

FIG. 5 is a block diagram representation of an example of an environment in which an on-demand database service can be used in accordance with some implementations and models;

FIG. 6 is a block diagram representation of example implementations of elements of FIG. 5 and example interconnections among these elements according to some implementations; and

FIG. 7 is a diagrammatic representation of a machine in an exemplary form of a computer system within which a set of instructions, for causing the machine to perform any one or more of the methodologies discussed herein, may be executed.

### DETAILED DESCRIPTION

Processor-implemented methods and systems are disclosed herein for optimizing pre-existing large language models. Different types of optimization techniques are provided to an offline optimization program. Within a generic model framework, different combinations of large language model serving configurations which contain model optimization configurations are generated. An automated online program optimizes the pre-existing large language models using the large language model optimization configurations.

As another example, a processor-implemented method and system are disclosed for optimizing pre-existing large language models. The method and system provide different types of optimization techniques to a processor-implemented offline optimization program. The offline optimization program includes a generic model framework for adding the different types of optimization techniques. Within the generic model framework, different combinations of large language model serving configurations are generated based upon the added different types of optimization techniques. The generic model framework is provided with the different combinations of large language model serving configurations to a processor-implemented online optimization program. A fully automated online program optimizes pre-existing large language models using the large language model serving configurations. At least one of the optimized pre-existing large language models is deployed within a production environment.

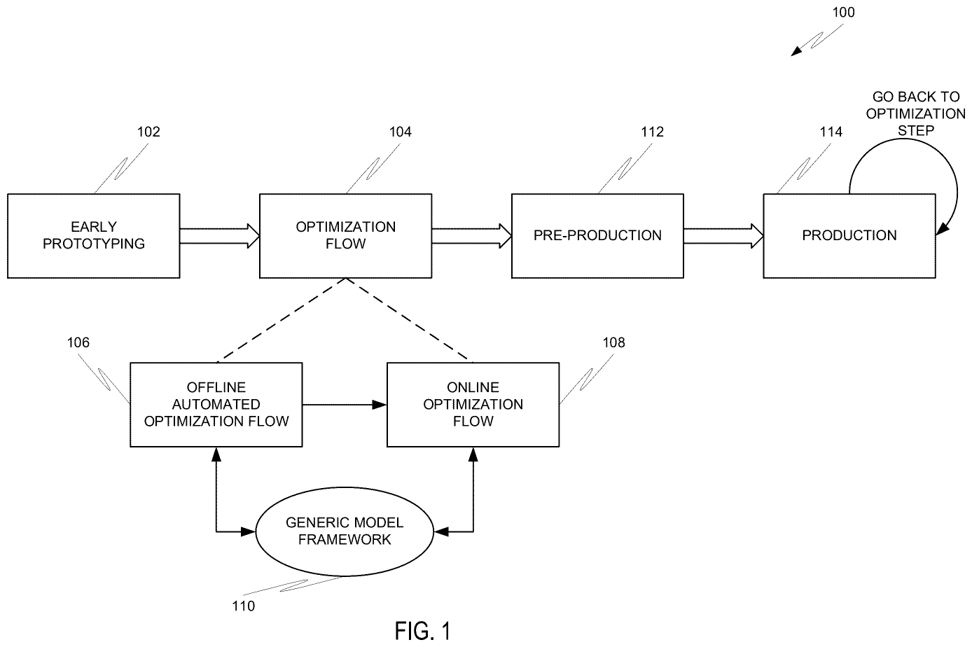

With reference to FIG. 1, a block diagram representation of a system 100 is depicted for optimizing pre-existing large language models (LLMs). In one example embodiment, the system 100 includes early prototyping 102. Early prototyping 102 focuses on generating a model serving working code within a machine learning service, such as but not limited to Amazon Web Service (AWS) SageMaker. SageMaker allows users to serve LLMs along with custom code as pre and post processing. Early prototyping 102 outputs the serving code and model files.

The outputs from early prototyping 102 are provided to optimization flow 104. Optimization flow 104 contains an offline automated model optimization flow 106 which automatically optimizes an LLM for improved performance and reduced cost for model serving requests.

The optimization flow 104 can be further extended to use a generic framework 110 within a combination of the offline automated model optimization flow 106 for new experimentation and optimization techniques and an online optimization flow 108 for continuous optimizations of existing models when models get updated and/or new optimization techniques are added. The generic framework 110 is accessed and utilized by both the offline automated model optimization flow 106 and the online optimization flow 108. The generic framework 110 is open and allows new optimization techniques to be added within the optimization flow 104.

The optimization flow 104 provides as output to the pre-production flow 112 the best serving method that is deployable. The optimization flow 104 also provides as output the platform configuration information. In one example, platform configuration information includes data detailing the setup and arrangement of the components in the system infrastructure that enable efficient deployment and serving LLMs.

The pre-production flow 112 results in the serving configuration working in the AI platform and further performs benchmark performance tests. After the pre-production flow 112 achieves satisfactory testing, then the pre-production flow 112 provides as output to the production environment 114 the onboard-to-AI platform and the AI platform serving configuration. When additional optimization may be needed for an LLM in the production environment 114, then processing returns to the optimization flow 104 where the offline automated model optimization flow 106 and online optimization flow 108 processes the LLM.

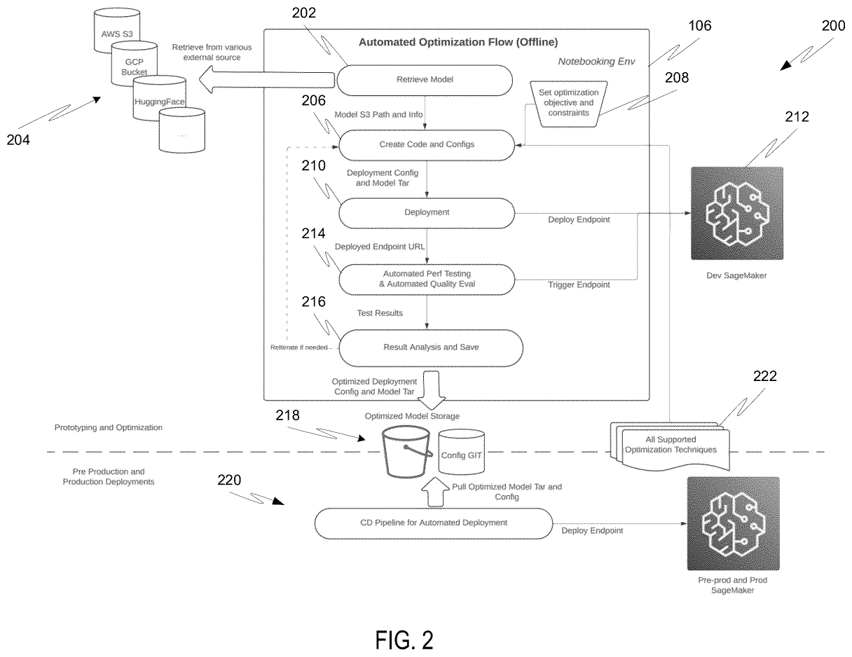

FIG. 2 is a process block diagram that depicts at 200 the operations performed by an example embodiment of the offline automated model optimization flow 106. At 202, a model is retrieved from various external sources 204. Examples of the various sources include AWS S3, GCP buckets, HuggingFace, etc. In this example, the model is saved to S3 and the corresponding model information is extracted.

At 206, model TAR files are generated as well as various configurations based on user optimization objectives, constraints, and a pre-existing list of supported optimization techniques 222. At 210, the model is deployed to SageMaker 212 to create an inferencing endpoint. At 214, given the inferencing endpoint, the automated performance testing and quality evaluations are executed.

At 216, the automated performance testing and quality evaluation results are gathered and analyzed in order to determine whether it is necessary to rerun with new sets of configurations and techniques, or if optimization results are satisfactory, the optimized deployable model TAR and model configurations 218 should be saved for pre-production and production deployments as shown at 220.

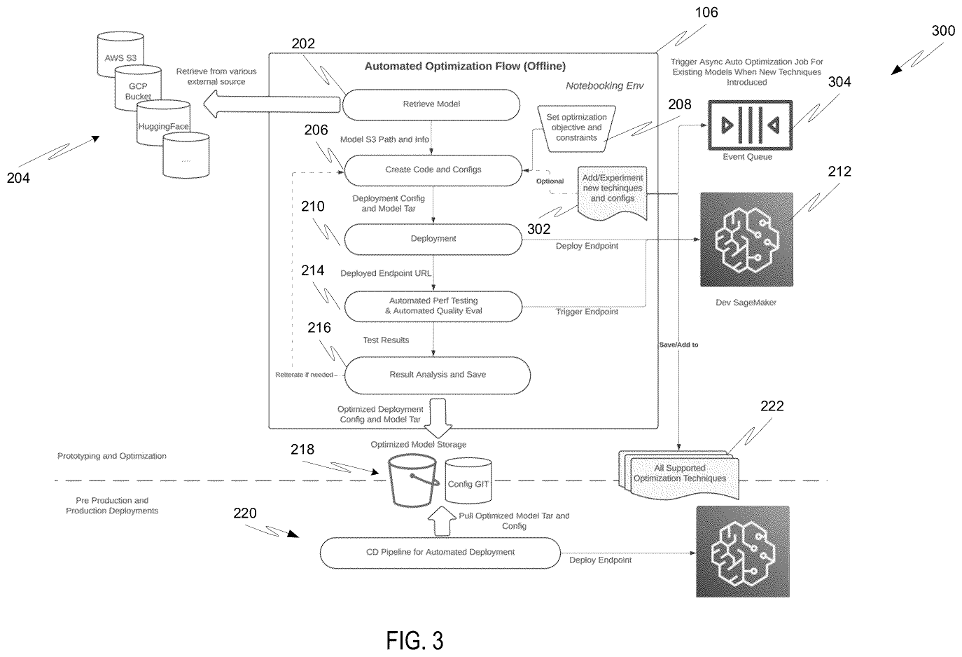

FIG. 3 is a process block diagram that depicts at 300 the operations performed by an example embodiment of the offline automated model optimization flow 106 where new optimization techniques are to be added. The figure also provides an example of the generic model framework that is open and facilitates the adding of the new optimization techniques.

The addition of new optimization techniques 302 occurs in the offline automated model optimization flow 106 so that engineers and data scientists can experiment with new optimization techniques when generating model TAR and model configurations. New optimization techniques are then saved to the existing list of supported optimization techniques 222 for later usage.

After the addition of the new optimization techniques at 302, an event queue 304 handles the triggering of a set of asynchronous jobs. The triggering of the set of asynchronous jobs runs the online optimization flow 108 so that the new optimization techniques 222 are automatically tested on existing models in production.

The addition of new techniques can be divided into two parts, where one is at the model TAR level, the other is at the model configuration level. More specifically, in order to support various frameworks (such as vLLM, TensorRT-LLM, llama.cpp) and different techniques (such as quantization, batching, CUDA kernels, speculative decoding, etc.), at the model TAR level, no specific constraint is enforced. In other words, as long as the model can be deployed as a SageMaker inferencing endpoint, the creation of model configuration, and performance/quality evaluation can all work with such an approach.

With respect to model configuration generation and selection, this is where schema and logic is enforced in order to create the search space for optimization, and ensure that configurations work with model TAR at deployment time. The configuration generation and selection is supplied as a customizable SDK so engineers and data scientist can more easily make additions.

The following provides an example of adding new configuration values:

$$batch\_size = [ 1 , 2 , 4 , 8 , 16 , 32 , 64 , 128 , 256 , 512 ]$$

$$use\_fused \_mlp = [ True , False ]$$

$$tensor\_parallel = [ 1 , 2 , 4 , 8 ]$$

#add new configuration key, value pairs here below

After adding new configurations, a Cartesian product which generates all combinations is performed. To ensure configurations work with each other as well as work for the model TAR, custom functions can be added to the configuration selection step by engineers and data scientist into SDK as shown in the following example:

```
def select_valid_config(config):
  if not_enough_gpu_given_tensor_parallel( ):
    return False
  if not_enough_gpu_memory_based_on_model_size_estimation( ):
    return False
  if fp8_quantization_not_work_on_old_gpu_architecture( ):
    return False
  # add new validation and selection logic below
return True
```

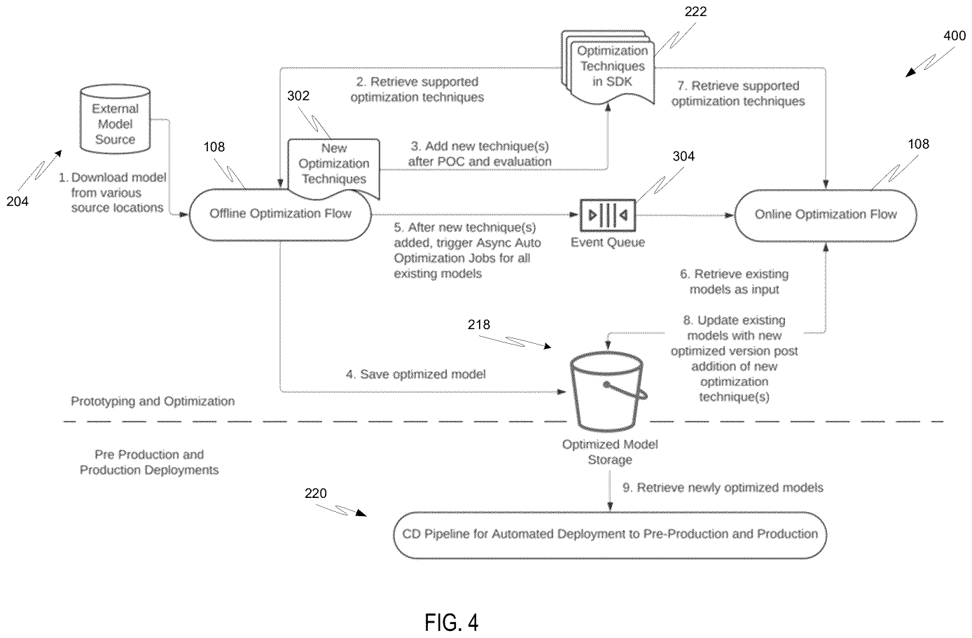

FIG. 4 is a process block diagram depicting an example of the offline automated model optimization flow 106 interacting with the online optimization flow 108 through the event queue 304 to form a complete optimization system.

At step 1 in FIG. 4, one or more models are downloaded from various source locations 204. At step 2, the offline automated model optimization flow 106 retrieves supported optimization techniques 222. At step 3, the new optimization techniques 302 are added after proof of concept and evaluation. At step 4 the optimized model is saved at the optimized model storage 218.

At step 5, the async auto optimization jobs are triggered via event queue 304 for all existing models after the new optimization techniques have been added. More specifically, step 5 shows the connection/trigger between the offline automated model optimization flow 106 and online optimization flow 108 where new versions of models and/or new optimization techniques are introduced, with the async online version of the optimization job being triggered in the background.

At step 6, the online optimization flow 108 retrieves the existing model as input. At step 7, the online optimization flow 108 retrieves the supported optimization techniques 222. At step 8, the online optimization flow 108 updates existing models with new optimized versions after the addition of any new optimization techniques. At step 9, the newly optimized models are automatically deployed to pre-production and post-production environments 220.

With respect to the example embodiment in FIG. 4, the separation of the offline automated model optimization flow 106 and the online optimization flow 108 provides significant technical benefits, such as for example, the offline automated model optimization flow 106 provides engineers and data scientists a Jupyter notebook-based environment to experiment and add new techniques while the online optimization flow 108 serves to continuously improve and optimize the models running in production for better outcome and also ensure that regression is not occurring after a new version of the model is introduced or new technique(s) are supported.

As can be appreciated in light of the disclosure, the order of operations within FIG. 4 and the other process block diagrams described herein is not limited to the sequential execution as illustrated in the figures but may be performed in one or more varying orders as applicable and in accordance with the present disclosure. Still further, such systems and methods described herein can provide automated model optimization for improved performance and reduced cost for model serving requests. Additionally, such systems and methods can configured to provide a unified framework that automates the entire model optimization steps, starting from prototyping to experimentation deployment, performance testing, and eventually the output being deployable in pre-production and production environments, while being extensible to new techniques and being flexible to meet different technical goals of cost-to-serve, latency, throughput requirements, etc.

The system 400 depicted in FIG. 4 can be further extended to include customizable optimization objects and constraints formulation to achieve business and technical goals for various use cases. More specifically, this is optimized with an objective function and constraint functions based upon a specific scenario's requirements, such as shown below:

$$\begin{matrix}\text{?} & \text{?} & \\ \text{?} & \text{?} & \text{?} \\ & \text{?} & \text{?}\end{matrix}$$

$$\text{?} \text{indicates text missing or illegible when filed}$$

where function f is the objective function and function g, h are constraints.

In the LLM serving world, latency dictates customer experience; throughput dictates how many customers can be served at the same time, hardware limitation is the constraint on GPU can be obtained and allocated; and cost-to-serve affects the eventual profitability.

The following provides examples of optimization with customizable optimization objects and constraints formulation.

### Scenario 1:

minimize f: total cost-to-serve
subject to:
   g: latency constraints
   h: throughput constraints, hardware constraints

Description of scenario 1: given acceptable customer experience and ability to support certain number of customers, achieve the lowest cost. This is the use case where reducing cost-to-serve is the main goal such as FlowGPT.

### Scenario 2:

minimize f: latency
subject to:
   g: total cost-to-serve
   h: throughput constrains, hardware constraints

Description of scenario 2: given acceptable cost and ability to support certain number of customers, achieve the best customer experience by finding the lowest latency. This is needed for use cases with very low latency requirements such as Autocomplete.

### Scenario 3:

$$minimize score = f ( \text{cost-to-serve} , latency and throughput )$$

for example:

$$score = \text{cost-to-serve} + latency * latency\_penalty \_factor + throughput\_penalty \_factor / throughput$$

subject to:
   g: latency constraints
   h: throughput constraints, hardware constraints

Description of scenario 3: in this formulation, the eventual goal is to have an overall balanced outcome between providing low cost-to-serve, reasonable latency and throughput as a whole. Customers can define the objective function as needed and the system can support these arbitrary objectives.

Still further with respect to the above scenarios, the following can be addressed through such optimization approaches: companies may host their own LLMs on Hawking to support large number of customers with the requirements to ensure low latency and high throughput and minimize cost. This is a significant technical benefit as the high cost of Nvidia GPUs and the ever-increasing number of customers and scenarios mean small improvements in the techniques would result in a large impact in cost savings, and the right balance of cost and serving performance can also lead to better customer experience.

Still further, the following can be addressed: the complex nature of LLMs running on GPUs efficiently; the manual process in previous other approaches limits the number of combinations/iterations of experimentations that can be taken; new optimization techniques arrive frequently in this dynamic field and frequent new experimentations are required; and a balanced combination of cost-to-serve, latency, and throughput is a significant benefit to accomplish through the disclosed systems and methods. In general, the systems and methods disclosed herein provide LLM serving configuration are generated and benchmarked for the best inference performance, lowest cost, and/or user-defined custom metrics.

Still further with respect to the above scenarios, systems and methods described herein can enable data scientists and machine learning engineers to perform the operations described with respect to the figures in an automated way. The systems and methods can also result in a significant reduction in the number of hours to perform such operations (e.g., less than 10 hours or even fewer depending upon the application at hand).

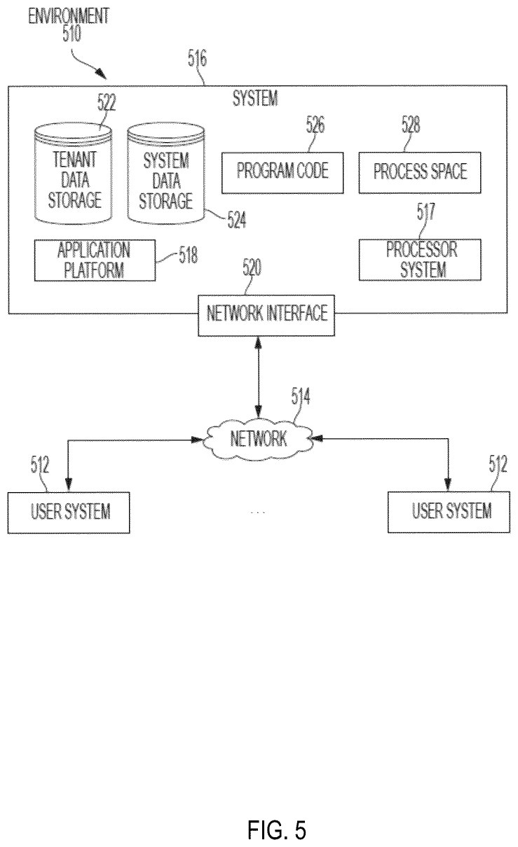

The deployed models as described herein can be used within many different software environments. As an example, FIG. 5 shows a block diagram of an example of an environment 510 in which an on-demand database service can be used with the software triaged in accordance with some implementations of the software triage quality systems and methods disclosed herein.

The environment 510 includes user systems 512 (also referred to a client device), a network 514, a database system 516 (also referred to herein as a “cloud-based system”), a processor system 517, an application platform 518, a network interface 520, tenant database 522 for storing tenant data 523, system database 524 for storing system data 525, program code 526 for implementing various functions of the system 516, and process space 528 for executing database system processes and tenant-specific processes, such as running applications as part of an application hosting service. In some other implementations, environment 510 may not have all of these components or systems, or may have other components or systems instead of, or in addition to, those listed above.

In some implementations, the environment 510 is an environment in which an on-demand database service exists. An on-demand database service, such as that which can be implemented using the system 516, is a service that is made available to users outside of the enterprise(s) that own, maintain or provide access to the system 516. As described above, such users generally do not need to be concerned with building or maintaining the system 516. Instead, resources provided by the system 516 may be available for such users' use when the users need services provided by the system 516; that is, on the demand of the users. Some on-demand database services can store information from one or more tenants into tables of a common database image to form a multi-tenant database system (MTS). The term “multi-tenant database system” can refer to those systems in which various elements of hardware and software of a database system may be shared by one or more customers or tenants. For example, a given application server may simultaneously process requests for a great number of customers, and a given database table may store rows of data such as feed items for a potentially much greater number of customers. A database image can include one or more database objects. A relational database management system (RDBMS) or the equivalent can execute storage and retrieval of information against the database object(s).

Application platform 518 can be a framework that allows the applications of system 516 to execute, such as the hardware or software infrastructure of the system 516. In some implementations, the application platform 518 enables the creation, management and execution of one or more applications developed by the provider of the on-demand database service, users accessing the on-demand database service via user systems 512, or third-party application users accessing the on-demand database service via user systems 512.

In some implementations, the system 516 implements a web-based customer relationship management (CRM) system. For example, in some such implementations, the system 516 includes application servers configured to implement and execute CRM software applications as well as provide related data, code, forms, renderable webpages and documents and other information to and from user systems 512 and to store to, and retrieve from, a database system related data, objects, and Webpage content. In some MTS implementations, data for multiple tenants may be stored in the same physical database object in tenant database 522. In some such implementations, tenant data is arranged in the storage medium(s) of tenant database 522 so that data of one tenant is kept logically separate from that of other tenants so that one tenant does not have access to another tenant's data, unless such data is expressly shared. The system 516 also implements applications other than, or in addition to, a CRM application. For example, the system 516 can provide tenant access to multiple hosted (standard and custom) applications, including a CRM application. User (or third-party user) applications, which may or may not include CRM, may be supported by the application platform 518. The application platform 518 manages the creation and storage of the applications into one or more database objects and the execution of the applications in one or more virtual machines in the process space of the system 516.

According to some implementations, each system 516 is configured to provide webpages, forms, applications, data and media content to user (client) systems 512 to support the access by user systems 512 as tenants of system 516. As such, system 516 provides security mechanisms to keep each tenant's data separate unless the data is shared. If more than one MTS is used, they may be located in close proximity to one another (for example, in a server farm located in a single building or campus), or they may be distributed at locations remote from one another (for example, one or more servers located in city A and one or more servers located in city B). As used herein, each MTS could include one or more logically or physically connected servers distributed locally or across one or more geographic locations. Additionally, the term “server” is meant to refer to a computing device or system, including processing hardware and process space(s), an associated storage medium such as a memory device or database, and, in some instances, a database application (for example, OODBMS or RDBMS) as is well known in the art. It should also be understood that “server system” and “server” are often used interchangeably herein. Similarly, the database objects described herein can be implemented as part of a single database, a distributed database, a collection of distributed databases, a database with redundant online or offline backups or other redundancies, etc., and can include a distributed database or storage network and associated processing intelligence.

The network 514 can be or include any network or combination of networks of systems or devices that communicate with one another. For example, the network 514 can be or include any one or any combination of a LAN (local area network), WAN (wide area network), telephone network, wireless network, cellular network, point-to-point network, star network, token ring network, hub network, or other appropriate configuration. The network 514 can include a TCP/IP (Transfer Control Protocol and Internet Protocol) network, such as the global internetwork of networks often referred to as the “Internet” (with a capital “I”). The Internet will be used in many of the examples herein. However, it should be understood that the networks that the disclosed implementations can use are not so limited, although TCP/IP is a frequently implemented protocol.

The user systems 512 can communicate with system 516 using TCP/IP and, at a higher network level, other common Internet protocols to communicate, such as HTTP, FTP, AFS, WAP, etc. In an example where HTTP is used, each user system 512 can include an HTTP client commonly referred to as a “web browser” or simply a “browser” for sending and receiving HTTP signals to and from an HTTP server of the system 516. Such an HTTP server can be implemented as the sole network interface 520 between the system 516 and the network 514, but other techniques can be used in addition to or instead of these techniques. In some implementations, the network interface 520 between the system 516 and the network 514 includes load sharing functionality, such as round-robin HTTP request distributors to balance loads and distribute incoming HTTP requests evenly over a number of servers. In MTS implementations, each of the servers can have access to the MTS data; however, other alternative configurations may be used instead.

The user systems 512 can be implemented as any computing device(s) or other data processing apparatus or systems usable by users to access the database system 516. For example, any of user systems 512 can be a desktop computer, a workstation, a laptop computer, a tablet computer, a handheld computing device, a mobile cellular phone (for example, a “smartphone”), or any other Wi-Fi-enabled device, wireless access protocol (WAP)-enabled device, or other computing device capable of interfacing directly or indirectly to the Internet or other network. The terms “user system” and “computing device” are used interchangeably herein with one another and with the term “computer.” As described above, each user system 512 typically executes an HTTP client, for example, a web browsing (or simply “browsing”) program, such as a web browser based on the WebKit platform, Microsoft's Internet Explorer browser, Netscape's Navigator browser, Opera's browser, Mozilla's Firefox browser, or a WAP-enabled browser in the case of a cellular phone, PDA or other wireless device, or the like, allowing a user (for example, a subscriber of on-demand services provided by the system 516) of the user system 512 to access, process and view information, pages and applications available to it from the system 516 over the network 514.

Each user system 512 also typically includes one or more user input devices, such as a keyboard, a mouse, a trackball, a touch pad, a touch screen, a pen or stylus or the like, for interacting with a graphical user interface (GUI) provided by the browser on a display (for example, a monitor screen, liquid crystal display (LCD), light-emitting diode (LED) display, among other possibilities) of the user system 512 in conjunction with pages, forms, applications and other information provided by the system 516 or other systems or servers. For example, the user interface device can be used to access data and applications hosted by system 516, and to perform searches on stored data, and otherwise allow a user to interact with various GUI pages that may be presented to a user. As discussed above, implementations are suitable for use with the Internet, although other networks can be used instead of or in addition to the Internet, such as an intranet, an extranet, a virtual private network (VPN), a non-TCP/IP based network, any LAN or WAN or the like.

The users of user systems 512 may differ in their respective capacities, and the capacity of a particular user system 512 can be entirely determined by permissions (permission levels) for the current user of such user system. For example, where a salesperson is using a particular user system 512 to interact with the system 516, that user system can have the capacities allotted to the salesperson. However, while an administrator is using that user system 512 to interact with the system 516, that user system can have the capacities allotted to that administrator. Where a hierarchical role model is used, users at one permission level can have access to applications, data, and database information accessible by a lower permission level user, but may not have access to certain applications, database information, and data accessible by a user at a higher permission level. Thus, different users generally will have different capabilities with regard to accessing and modifying application and database information, depending on the users' respective security or permission levels (also referred to as “authorizations”).

According to some implementations, each user system 512 and some or all of its components are operator-configurable using applications, such as a browser, including computer code executed using a central processing unit (CPU) such as an Intel Pentium® processor or the like. Similarly, the system 516 (and additional instances of an MTS, where more than one is present) and all of its components can be operator-configurable using application(s) including computer code to run using the processor system 517, which may be implemented to include a CPU, which may include an Intel Pentium® processor or the like, or multiple CPUs.

The system 516 includes tangible computer-readable media having non-transitory instructions stored thereon/in that are executable by or used to program a server or other computing system (or collection of such servers or computing systems) to perform some of the implementation of processes described herein. For example, computer program code 526 can implement instructions for operating and configuring the system 516 to intercommunicate and to process webpages, applications and other data and media content as described herein. In some implementations, the computer code 526 can be downloadable and stored on a hard disk, but the entire program code, or portions thereof, also can be stored in any other volatile or non-volatile memory medium or device as is well known, such as a ROM or RAM, or provided on any media capable of storing program code, such as any type of rotating media including floppy disks, optical discs, digital versatile disks (DVD), compact disks (CD), microdrives, and magneto-optical disks, and magnetic or optical cards, nanosystems (including molecular memory ICs), or any other type of computer-readable medium or device suitable for storing instructions or data. Additionally, the entire program code, or portions thereof, may be transmitted and downloaded from a software source over a transmission medium, for example, over the Internet, or from another server, as is well known, or transmitted over any other existing network connection as is well known (for example, extranet, VPN, LAN, etc.) using any communication medium and protocols (for example, TCP/IP, HTTP, HTTPS, Ethernet, etc.) as are well known. It will also be appreciated that computer code for the disclosed implementations can be realized in any programming language that can be executed on a server or other computing system such as, for example, C, C++, HTML, any other markup language, JAVA®, JAVASCRIPT®, ActiveX®, any other scripting language, such as VBScript®, and many other programming languages as are well known may be used. (JAVA™ is a trademark of Sun Microsystems, Inc.).

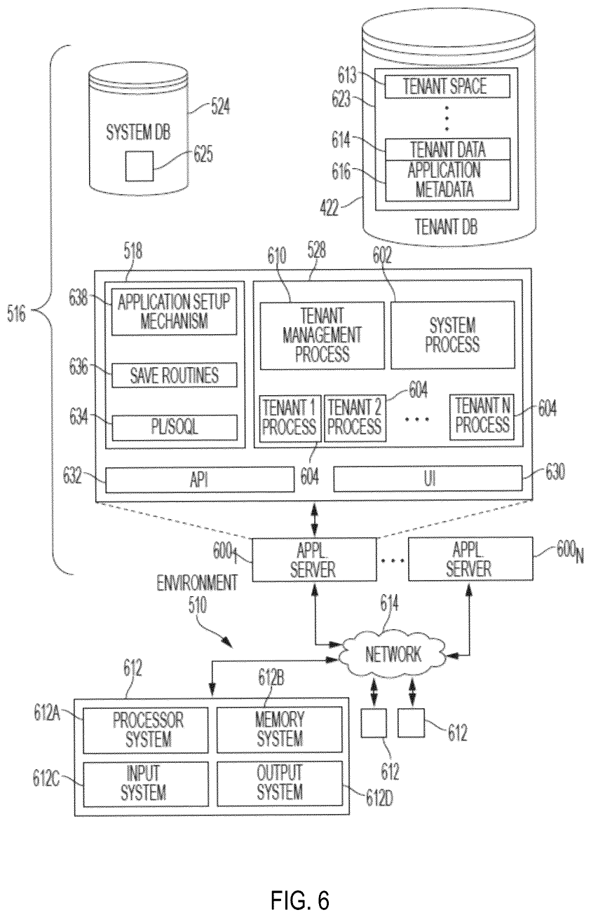

FIG. 6 shows a block diagram of example implementations of elements in FIG. 5 and example interconnections between these elements according to some implementations. That is, FIG. 6 also illustrates environment 510, but FIG. 6, various elements of the system 516 and various interconnections between such elements are shown with more specificity according to some more specific implementations. Elements from FIG. 6 that are also shown in FIG. 5 will use the same reference numbers in FIG. 6 as were used in FIG. 5. Additionally, in FIG. 6, the user system 612 includes a processor system 612A, a memory system 612B, an input system 612C, and an output system 612D. The processor system 612A can include any suitable combination of one or more processors. The memory system 612B can include any suitable combination of one or more memory devices. The input system 612C can include any suitable combination of input devices, such as one or more touchscreen interfaces, keyboards, mice, trackballs, scanners, cameras, or interfaces to networks. The output system 612D can include any suitable combination of output devices, such as one or more display devices, printers, or interfaces to networks.

In FIG. 6, the network interface 520 of FIG. 5 is implemented as a set of HTTP application servers 6001-600N. Each application server 600, also referred to herein as an “app server,” is configured to communicate with tenant database 522 and the tenant data 623 therein, as well as system database 524 and the system data 625 therein, to serve requests received from the user systems 612. The tenant data 623 can be divided into individual tenant storage spaces 613, which can be physically or logically arranged or divided. Within each tenant storage space 613, tenant data 614 and application metadata 616 can similarly be allocated for each user. For example, a copy of a user's most recently used (MRU) items can be stored to tenant data 614. Similarly, a copy of MRU items for an entire organization that is a tenant can be stored to tenant storage space 613.

The process space 528 includes system process space 602, individual tenant process spaces 604 and a tenant management process space 610. The application platform 518 includes an application setup mechanism 638 that supports application users' creation and management of applications. Such applications and others can be saved as metadata into tenant database 522 by save routines 636 for execution by subscribers as one or more tenant process spaces 604 managed by tenant management process 610, for example. Invocations to such applications can be coded using PL/SOQL 634, which provides a programming language style interface extension to API 632. Invocations to applications can be detected by one or more system processes, which manage retrieving application metadata 616 for the subscriber making the invocation and executing the metadata as an application in a virtual machine.

The system 516 of FIG. 6 also includes a user interface (UI) 630 and an application programming interface (API) 632 to system 516 resident processes to users or users at user systems 612. In some other implementations, the environment 510 may not have the same elements as those listed above or may have other elements instead of, or in addition to, those listed above.

Each application server 600 can be communicably coupled with tenant database 522 and system database 524, for example, having access to tenant data 623 and system data 625, respectively, via a different network connection. For example, one application server 6001 can be coupled via the network 514 (for example, the Internet), another application server 600N can be coupled via a direct network link, and another application server (not illustrated) can be coupled by yet a different network connection. Transfer Control Protocol and Internet Protocol (TCP/IP) are examples of typical protocols that can be used for communicating between application servers 600 and the system 516. However, it will be apparent to one skilled in the art that other transport protocols can be used to optimize the system 516 depending on the network interconnections used.

In some implementations, each application server 600 is configured to handle requests for any user associated with any organization that is a tenant of the system 516. Because it can be desirable to be able to add and remove application servers 600 from the server pool at any time and for various reasons, in some implementations there is no server affinity for a user or organization to a specific application server 600. In some such implementations, an interface system implementing a load balancing function (for example, an F5 Big-IP load balancer) is communicably coupled between the application servers 600 and the user systems 612 to distribute requests to the application servers 600. In one implementation, the load balancer uses a least-connections algorithm to route user requests to the application servers 600. Other examples of load balancing algorithms, such as round robin and observed-response-time, also can be used. For example, in some instances, three consecutive requests from the same user could hit three different application servers 600, and three requests from different users could hit the same application server 600. In this manner, by way of example, system 516 can be a multi-tenant system in which system 516 handles storage of, and access to, different objects, data and applications across disparate users and organizations.

In one example storage use case, one tenant can be a company that employs a sales force where each salesperson uses system 516 to manage aspects of their sales. A user can maintain contact data, leads data, customer follow-up data, performance data, goals and progress data, etc., all applicable to that user's personal sales process (for example, in tenant database 522). In an example of an MTS arrangement, because all of the data and the applications to access, view, modify, report, transmit, calculate, etc., can be maintained and accessed by a user system 612 having little more than network access, the user can manage his or her sales efforts and cycles from any of many different user systems. For example, when a salesperson is visiting a customer and the customer has Internet access in their lobby, the salesperson can obtain critical updates regarding that customer while waiting for the customer to arrive in the lobby.

While each user's data can be stored separately from other users' data regardless of the employers of each user, some data can be organization-wide data shared or accessible by several users or all of the users for a given organization that is a tenant. Thus, there can be some data structures managed by system 516 that are allocated at the tenant level while other data structures can be managed at the user level. Because an MTS can support multiple tenants including possible competitors, the MTS can have security protocols that keep data, applications, and application use separate. Also, because many tenants may opt for access to an MTS rather than maintain their own system, redundancy, up-time, and backup are additional functions that can be implemented in the MTS. In addition to user-specific data and tenant-specific data, the system 516 also can maintain system level data usable by multiple tenants or other data. Such system level data can include industry reports, news, postings, and the like that are sharable among tenants.

In some implementations, the user systems 612 (which also can be client systems) communicate with the application servers 600 to request and update system-level and tenant-level data from the system 516. Such requests and updates can involve sending one or more queries to tenant database 522 or system database 524. The system 516 (for example, an application server 600 in the system 516) can automatically generate one or more SQL statements (for example, one or more SQL queries) designed to access the desired information. System database 524 can generate query plans to access the requested data from the database. The term “query plan” generally refers to one or more operations used to access information in a database system.

Each database can generally be viewed as a collection of objects, such as a set of logical tables, containing data fitted into predefined or customizable categories. A “table” is one representation of a data object and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or element of a table can contain an instance of data for each category defined by the fields. For example, a CRM database can include a table that describes a customer with fields for basic contact information such as name, address, phone number, fax number, etc. Another table can describe a purchase order, including fields for information such as customer, product, sale price, date, etc. In some MTS implementations, standard entity tables can be provided for use by all tenants. For CRM database applications, such standard entities can include tables for case, account, contact, lead, and opportunity data objects, each containing pre-defined fields. As used herein, the term “entity” also may be used interchangeably with “object” and “table.”

In some MTS implementations, tenants are allowed to create and store custom objects or may be allowed to customize standard entities or objects, for example by creating custom fields for standard objects, including custom index fields. In some implementations, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

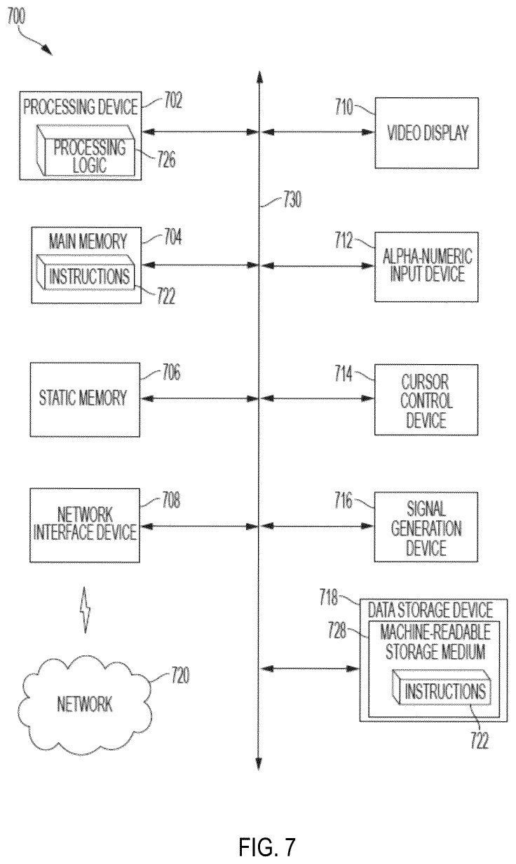

FIG. 7 illustrates a diagrammatic representation of a machine in the exemplary form of a computer system 700 within which a set of instructions for causing the machine to perform any one or more of the methodologies discussed herein, may be executed. The system 700 may be in the form of a computer system within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a user system, a client device, or a server machine in client-server network environment. The machine may be a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In at least one embodiment, computer system 700 may represent, for example, elements of the cloud-based computing platform or any other elements of FIG. 1 (e.g. clients, computing systems used by the customers 150, the third-party application exchange 160) or any elements of FIGS. 7 through 5, etc.

Processing device 702 represents one or more general-purpose processing devices such as a microprocessor, central processing unit, or the like. More particularly, the processing device 702 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 702 may also be one or more special-purpose processing devices such as an application specific integrated circuit (ASIC), a field programmable gate array (FPGA), a digital signal processor (DSP), network processor, or the like.

The computer system 700 may further include a network interface device 708. The computer system 700 also may include a video display unit 710 (e.g., a liquid crystal display (LCD) or a cathode ray tube (CRT)), an alphanumeric input device 712 (e.g., a keyboard), a cursor control device 714 (e.g., a mouse), and a signal generation device 716 (e.g., a speaker).

The data storage device 718 may include a computer-readable medium 728 on which is stored one or more sets of instructions 722 (e.g., instructions of in-memory buffer service 94) embodying any one or more of the methodologies or functions described herein. The instructions 722 may also reside, completely or at least partially, within the main memory 704 and/or within processing logic 726 of the processing device 702 during execution thereof by the computer system 700, the main memory 704 and the processing device 702 also constituting computer-readable media. The instructions may further be transmitted or received over a network 720 via the network interface device 708.

While the computer-readable storage medium 728 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

Particular embodiments may be implemented in a computer-readable storage medium (also referred to as a machine-readable storage medium) for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

A “processor,” “processor system,” or “processing system” includes any suitable hardware and/or software system, mechanism or component that processes data, signals or other information. A processor can include a system with a general-purpose central processing unit, multiple processing units, dedicated circuitry for achieving functionality, or other systems. Processing need not be limited to a geographic location or have temporal limitations. For example, a processor can perform its functions in “real time,” “offline,” in a “batch mode,” etc. Portions of processing can be performed at different times and at different locations, by different (or the same) processing systems. A computer may be any processor in communication with a memory. The memory may be any suitable processor-readable storage medium, such as random-access memory (RAM), read-only memory (ROM), magnetic or optical disk, or other tangible media suitable for storing instructions for execution by the processor.

Particular embodiments may be implemented by using a programmed general-purpose digital computer, by using a special-purpose computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular implementations may vary from these exemplary details and still be contemplated to be within the scope of the present disclosure.

In the above description, numerous details are set forth. It will be apparent, however, to one of ordinary skill in the art having the benefit of this disclosure, that embodiments of the disclosure may be practiced without these specific details. In some instances, well-known structures and devices are shown in block diagram form, rather than in detail, in order to avoid obscuring the description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In this regard, it should be appreciated that the various block components shown in the figures may be realized by any number of hardware, software, and/or firmware components configured to perform the specified functions. For example, at least one embodiment of a system or a component may employ various integrated circuit components, e.g., memory elements, digital signal processing elements, logic elements, look-up tables, or the like, which may carry out a variety of functions under the control of one or more microprocessors or other control devices.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing,” “determining,” “analyzing,” “identifying,” “adding,” “displaying,” “generating,” “querying,” “creating,” “selecting” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments of the disclosure also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present disclosure is not described with reference to any particular programming language. It will be appreciated that a variety of programming languages may be used to implement the teachings of the disclosure as described herein.

Any suitable programming language can be used to implement the routines of particular embodiments including C, C++, JAVA®, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, or detailed description.

While at least one example embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those of ordinary skill in the art with a convenient road map for implementing the described embodiments. It should be understood that various changes can be made in the function and arrangement of elements without departing from the scope defined by the claims, which includes known equivalents and foreseeable equivalents at the time of filing this patent application.

What is claimed is:

1. A processor-implemented method for optimizing pre-existing large language models, said method comprising:
providing, by one or more data processors, different types of optimization techniques to a processor-implemented offline optimization program;
wherein the offline optimization program includes a generic model framework for adding the different types of optimization techniques;
generating within the generic model framework, by the one or more data processors, different combinations of large language model serving configurations, which contain model optimization configurations, based upon the added different types of optimization techniques;
providing the generic model framework with the different combinations of large language model serving configurations to a processor-implemented online optimization program;
wherein the fully automated online program optimizes pre-existing large language models using the large language model optimization configurations; and
deploying at least one of the optimized pre-existing large language models within a production environment.

2. The method of claim 1, wherein the generating within the generic model framework occurs within a large language model optimization environment.

3. The method of claim 2, wherein the large language model optimization environment includes an early prototyping process, a pre-production environment, and the production environment.

4. The method of claim 1, wherein the offline optimization program and the online program automatically optimize a large language model for improved performance and reduced cost for model serving requests.

5. The method of claim 1, wherein addition of new optimization techniques occurs in the offline automated model optimization flow through the generic model framework so that experimentation with new optimization techniques occurs.

6. The method of claim 1, wherein an event queue handles triggering a set of asynchronous jobs.

7. The method of claim 1, wherein the triggering of set of asynchronous jobs automatically tests the new optimization techniques on existing models in production

8. The method of claim 1, wherein separation of the offline optimization program and the online optimization program provide optimization through a Jupyter notebook-based environment to experiment and add new optimization techniques while the online optimization program serves to continuously improve and optimize the models running in production.

9. The method of claim 1, further comprising customizable optimization objects and constraints formulation being used to achieve technical performance goals with optimization being performed with an objective function and constraint functions.

10. The method of claim 9, wherein the constraints include latency constraints, throughput constraints, and hardware constraints.

11. A system for optimizing pre-existing large language models, the system comprising:
at least one or more processors; and
at least one non-transitory machine-readable storage medium that stores instructions configurable to be executed by the at least one processor to:
provide different types of optimization techniques to a processor-implemented offline optimization program;
wherein the offline optimization program includes a generic model framework for adding the different types of optimization techniques;
generate within the generic model framework different combinations of large language model serving configurations, which contain model optimization configurations, based upon the added different types of optimization techniques;
provide the generic model framework with the different combinations of large language model serving configurations to a processor-implemented online optimization program;
wherein the fully automated online program optimizes pre-existing large language models using the large language model optimization configurations; and
deploy at least one of the optimized pre-existing large language models within a production environment.

12. The system of claim 11, wherein the generating within the generic model framework occurs within a large language model optimization environment.

13. The system of claim 12, wherein the large language model optimization environment includes an early prototyping process, a pre-production environment, and the production environment.

14. The system of claim 11, wherein the offline optimization program and the online program automatically optimize a large language model for improved performance and reduced cost for model serving requests.

15. The system of claim 11, wherein addition of new optimization techniques occurs in the offline automated model optimization flow through the generic model framework so that experimentation with new optimization techniques occurs.

16. The system of claim 11, wherein an event queue handles triggering a set of asynchronous jobs.

17. The system of claim 11, wherein the triggering of set of asynchronous jobs automatically tests the new optimization techniques on existing models in production

18. The system of claim 11, wherein separation of the offline optimization program and the online optimization program provide optimization through a Jupyter notebook-based environment to experiment and add new optimization techniques while the online optimization program serves to continuously improve and optimize the models running in production.

19. The system of claim 11, further comprising customizable optimization objects and constraints formulation being used to achieve technical performance goals with optimization being performed with an objective function and constraint functions;
wherein the constraints include latency constraints, throughput constraints, and hardware constraints.

20. A non-transitory machine-readable storage medium that stores instructions executable by at least one or more processors, the instructions configurable to cause the at least one processor to perform operations comprising:
providing, by one or more data processors, different types of optimization techniques to a processor-implemented offline optimization program;
wherein the offline optimization program includes a generic model framework for adding the different types of optimization techniques;
generating within the generic model framework, by the one or more data processors, different combinations of large language model configurations based upon the added different types of optimization techniques;
providing the generic model framework with the different combinations of large language model configurations to a processor-implemented online optimization program;
wherein the fully automated online program optimizes pre-existing large language models using the large language model configurations; and
deploying at least one of the optimized pre-existing large language models within a production environment.
